(19) United States
(12) Patent Application Publication
(10) Pub. No.: US 2026/0229015 A1
(43) Pub. Date: Aug. 6, 2026

(54) OBJECT DETECTION

(71) Applicant: Telefonaktiebolaget LM Ericsson (publ), Stockholm (SE)

(72) Inventors: Clara GOMEZ BLAZQUEZ, Madrid (ES); Alejandra HERNANDEZ SILVA, Solna (SE); José ARAÚJO, Stockholm (SE); Paula CARBÓ CUBERO, Stockholm (SE); André MATEUS, Uppsala (SE); David UMSONST, Bromma (SE); Adam MIKSITS, Solna (SE)

(73) Assignee: Telefonaktiebolaget LM Ericsson (publ), Stockholm (SE)

(21) Appl. No.: 19/152,224

(22) PCT Filed: Jan. 31, 2023
(86) PCT No.: PCT/EP2023/052240

§ 371 Date: Jul. 30, 2025

(51) Int. Cl. G06V 10/764; G06T 7/20; G06V 10/75; G06V 10/96; G06V 20/70

(52) U.S. Cl. CPC G06V 10/764; G06T 7/20; G06V 10/759; G06V 10/96; G06V 20/70; G06V 2201/07

(57) ABSTRACT

It is provided a method for detecting objects in an image, the method being performed by a mobile device. The method comprises: obtaining an image to process; performing tracking to find any tracked objects in the image, wherein any tracked objects have been identified in a previous image; performing category object detecting of the image, resulting in a respective category label for each detected object; and sending a request to a server to perform specific object detecting of at least one object detected in the category object detecting, wherein the specific object detecting is a more granular object detecting than the category object detecting.

### TECHNICAL FIELD

The present disclosure relates to the field of object detection and in particular to a method, mobile device, computer program and computer program product for detecting objects in an image.

### BACKGROUND

Object detection of images can be used for many purposes, e.g. in XR (extended reality) applications, automated vehicles, traffic surveillance, etc. However, object detection processes often consume more resources than are available in resource-constrained mobile devices that capture the images. The mobile device can have constrained resources, e.g. due to limited battery power and/or limited computing capabilities. The mobile device is equipped with an imaging device (e. g. monocular camera, stereo camera, depth camera) that provides images to an object detection pipeline. In order to offload processing from the mobile device, a remote server can be used to perform more powerful computations.

Wang, et al “Tiling small object detection for edge assisted autonomous mobile vision”. IEEE INFOCOM 2021-IEEE Conference on Computer Communications (pp. 1-10) discloses local object detection (in the mobile device) as well as offloaded object detection (in edge/cloud). Local object detection yields low accuracy on small objects since it operates on low-resolution videos to fit in mobile memory. Offloaded object detection incurs high latency due to uploading high-resolution videos to the edge/cloud. Large objects are detected locally while small object detection is offloaded to the edge. Wang presents an edge-device collaborative framework for enhancing small object detection with tile-level parallelism. It coordinates the offloaded detection pipeline in tiles rather than the entire image for accuracy and latency purposes. Specifically, a lightweight object detection in the mobile device (by lowering the resolution of the images) that identified the large objects in the image while small objects detection to the edge (by keeping a high resolution of the images).

Accurate object detection (OD) is a computationally demanding task as it requires Deep learning (DL) inference. In addition, fast execution is needed in order to be useful for other applications such as SLAM (simultaneous localisation and mapping) or online semantic mapping, as well as to be acceptable for user experience applications, as XR.

### SUMMARY

One object is to improve object detection by reducing response speeds while still allowing accurate object detection.

According to a first aspect, it is provided a method for detecting objects in an image, the method being performed by a mobile device. The method comprises: obtaining an image to process; performing tracking to find any tracked objects in the image, wherein any tracked objects have been identified in a previous image; performing category object detecting of the image, resulting in a respective category label for each detected object; and sending a request to a server to perform specific object detecting of at least one object detected in the category object detecting, wherein the specific object detecting is a more granular object detecting than the category object detecting.

This enables a mobile device to perform accurate and low-computational object detection first using the lightweight category object detection. By reducing the number of labels from which to choose (category labels are fewer than specific labels), we allow less power-demanding and faster object detection inference in the mobile device. In addition, as elements from the same category may share similar appearance, we can increase accuracy by reducing the number of object detection errors between similar objects.

The method may further comprise: receiving a response from the server, the response comprising at least one specific label for each object indicated in the request; and merging the category label and the specific label for at least one object indicated in the request.

The merging may comprise, for each merged object, setting a category label to the most likely detected category label and setting a specific label detection to the most likely detected specific label.

The category object detecting may result in a single most likely category label for each object, in which case the response comprises m most likely specific labels for each object. The merging then comprises, for each merged object, finding within the m most likely specific labels a matching specific label that is a species of the single most likely category object, setting the category label for the merged object to the single most likely category label and setting the specific label to the matching specific label.

The category object detecting may result in n most likely category labels for each object, in which case the response comprises m most likely specific labels for each object. The merging then comprises, for each merged object, finding a matching category label, within the n most likely category labels, that is a genus of at least one of the m most likely specific labels, denoted a matching specific label, setting the category label for the merged object to the matching category label and setting the specific label to the matching specific label.

The tracking and the category object detecting may be based on the whole image.

The method may further comprise, prior to the performing category object detecting: determining a non-tracking region within the image, wherein the non-tracking region excludes all object(s) that are tracked in the performing tracking. In this case, the performing category object detecting is performed only for the non-tracking region.

The method may further comprise, prior to the performing tracking: determining one or more suggested regions in the image for category object detecting; and, after the performing tracking, matching the one or more suggested regions proposals against respective locations in the image of tracked objects. In this case, the performing category object detecting is performed only for any suggested regions where no match is found against tracked objects.

The method may further comprise: determining a specific object detection set, consisting of at least one object that is to be detected using specific object detecting. In this case, in the sending a request, the request is for a server to perform specific object detecting only for any objects in the specific object detection set.

The specific object detection set may contain any objects that have been category detected but is not a tracked object.

The specific object detection set may contain any objects for which a previous iteration of merging the category label and the specific label was inconclusive.

The sending a request may be performed less frequently than the performing category object detecting of the image.

According to a second aspect, it is provided a mobile device for detecting objects in an image. The mobile device comprises: a processor; and a memory storing instructions that, when executed by the processor, cause the mobile device to: obtain an image to process; perform tracking to find any tracked objects in the image, wherein any tracked objects have been identified in a previous image; perform category object detecting of the image, resulting in a respective category label for each detected object; and send a request to a server to perform specific object detecting of at least one object detected in the category object detecting, wherein the specific object detecting is a more granular object detecting than the category object detecting.

The mobile device may further comprise instructions that, when executed by the processor, cause the mobile device to: receive a response from the server, the response comprising at least one specific label for each object indicated in the request; and merge the category label and the specific label for at least one object indicated in the request.

The instructions to merge may comprise instructions that, when executed by the processor, cause the mobile device to, for each merged object, set a category label to the most likely detected category label and set a specific label detection to the most likely detected specific label.

The category object detecting may result in a single most likely category label for each object, and the response comprises m most likely specific labels for each object. In this case, the instructions to merge comprise instructions that, when executed by the processor, cause the mobile device to, for each merged object, find within the m most likely specific labels a matching specific label that is a species of the single most likely category object, set the category label for the merged object to the single most likely category label and set the specific label to the matching specific label.

The category object detecting may result in n most likely category labels for each object, and the response comprises m most likely specific labels for each object. In this case, the instructions to merge comprise instructions that, when executed by the processor, cause the mobile device to, for each merged object, find a matching category label, within the n most likely category labels, that is a genus of at least one of the m most likely specific labels, denoted a matching specific label, set the category label for the merged object to the matching category label and set the specific label to the matching specific label.

The tracking and the category object detecting may be based on the whole image.

The mobile device may further comprise instructions that, when executed by the processor prior to the performing category object detecting, cause the mobile device to: determine a non-tracking region within the image, wherein the non-tracking region excludes all object(s) that are tracked in the performing tracking. In this case, the instructions to perform category object detecting is performed only for the non-tracking region.

The mobile device may further comprise instructions that, when executed by the processor prior to the performing tracking, cause the mobile device: determine one or more suggested regions in the image for category object detecting; and, instructions that, when executed by the processor after the performing tracking, cause the mobile device to match the one or more suggested regions proposals against respective locations in the image of tracked objects. In this case, the performing category object detecting is performed only for any suggested regions where no match is found against tracked objects.

The mobile device may further comprise instructions that, when executed by the processor, cause the mobile device to: determine a specific object detection set, consisting of at least one object that is to be detected using specific object detecting. In this case, in the instructions to send a request, the request is for a server to perform specific object detecting only for any objects in the specific object detection set.

The specific object detection set may contain any objects that have been category detected but is not a tracked object.

The specific object detection set may contain any objects for which a previous iteration of instructions to merge the category label and the specific label was inconclusive.

The instructions to send a request may be performed less frequently than the instructions to perform category object detecting of the image.

According to a third aspect, it is provided a computer program for detecting objects in an image. The computer program comprised computer program code which, when executed on a mobile device causes the mobile device to: obtain an image to process; perform tracking to find any tracked objects in the image, wherein any tracked objects have been identified in a previous image; perform category object detecting of the image, resulting in a respective category label for each detected object; and send a request to a server to perform specific object detecting of at least one object detected in the category object detecting, wherein the specific object detecting is a more granular object detecting than the category object detecting.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A-B are schematic diagrams illustrating how tracking is used in object detection;

FIGS. 3A-D are flow charts illustrating embodiments of methods for detecting objects in an image;

FIG. 4 is a schematic diagram illustrating components of the mobile device of FIG. 1 according to one embodiment;

FIG. 5 is a schematic diagram showing functional modules of the mobile device of FIG. 1 according to one embodiment; and

FIG. 6 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein provide two-level object detection (OD) that is particularly useful for constrained mobile devices. The method makes use of a constrained mobile device and a powerful server, e.g. in the edge or in the cloud. The mobile device performs category object detection of images, while the server is only used when needed to provide a more accurate specific object detection.

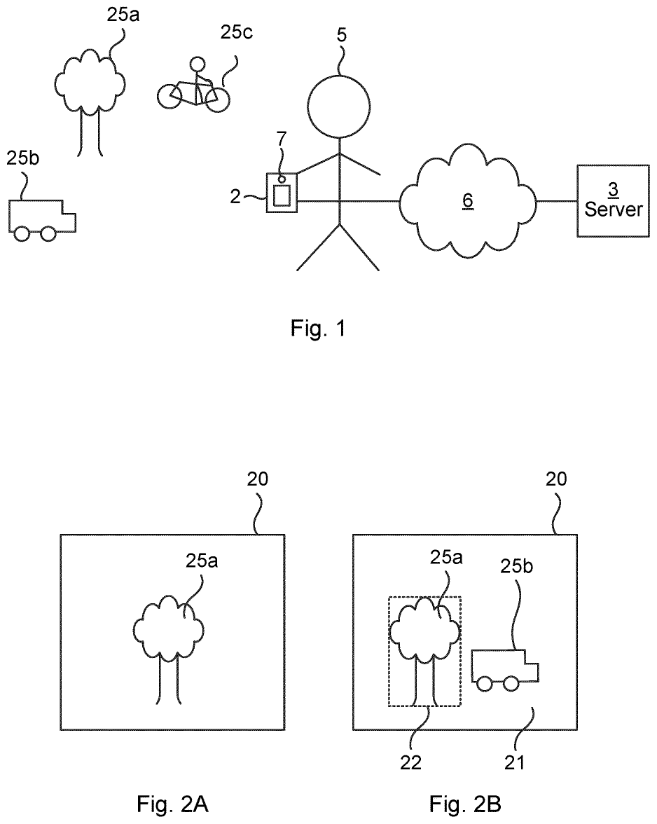

FIG. 1 is a schematic diagram illustrating an environment in which embodiments presented herein can be applied. A user 5 carries a mobile device 2. The mobile device 2 can be a smartphone, mobile phone, wearable device (e.g. smart glasses or smart jewellery), etc. The mobile device comprises an imaging device 7, e.g. in the form of a camera, stereo camera, depth camera, optionally combined with lidar, radar, etc., that provides images. The images capture the environment around the user 5 of the mobile device 2. For instance, the image can capture a tree 25a, a car 25b and a bicycle 25c. It is to be noted that the terms image, image frame and frame are all terms that are used interchangeably herein.

The mobile device 2 comprises an I/O interface for connecting to a wide area network 6, such as the Internet, e.g. via Wi-Fi or a cellular network, to allow communication with a server 3. The server 3 can be what is known as an edge server (located topologically close to the mobile device 2) or a cloud server (located topologically more centrally).

According to embodiments presented herein, the mobile device 2 can perform category detection, resulting in a category label for each object. Meanwhile, the server 3 is exploited for specific detection, resulting in a specific label for each object.

The category label is a genus of the specific label (when misclassifications do not occur). For object 25a, the category label can be tree, while the specific label can be an oak tree. For object 25b, the category label can be vehicle, while the specific label can be a lorry. For object 25c, the category label can be vehicle, while the specific label can be a bicycle.

FIGS. 2A-B are schematic diagrams illustrating how tracking is used in object detection. FIG. 2A shows an image 20 with a single object, a tree 25a, or more specifically, an oak tree. FIG. 2B shows an image 20 captured at a time after the image of FIG. 2A. Now, the camera has adjusted its field-of-view slightly to the right (indicated by the tree 25a moving slightly to the left), and there is a new object in the form of a vehicle 25b, or more specifically a lorry. In FIG. 2B, the tree 25a can be tracked from the previous image of 2A. A bounding box can be applied, being the smallest rectangle that encompasses the object, in this case around the tree 25a. This region is called a tracked region 22, since it contains a tracked object. All other parts of the image 20 are denoted a non-tracked region 21. It is thus seen how each captured image (except the very first image) can contain zero or more tracked objects and zero or more non-tracked objects. Non-tracked objects are also called new objects herein, since they are not part of the tracking and thus cannot be associated with previous image frames.

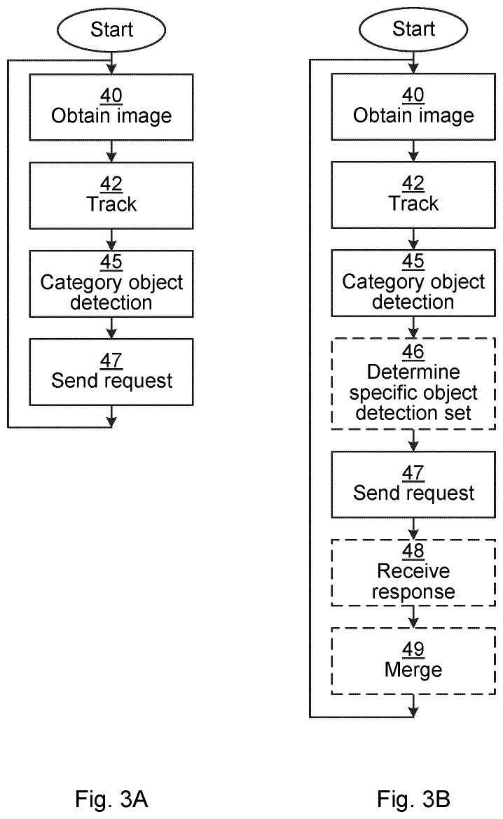

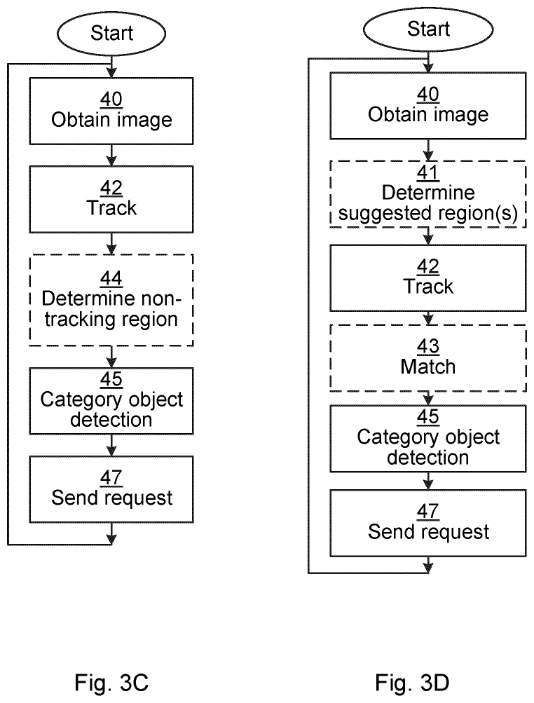

FIGS. 3A-D are flow charts illustrating embodiments of methods for detecting objects in an image 10. The method is performed by a mobile device 2. The method is performed when a requesting application wants to obtain object tracking of images of the mobile device. The requesting application can be an XR application, an automated vehicle application, a traffic monitoring application, etc.

In an obtain image step 40, the mobile device 2 obtains an image 20 to process. As described above, the image can be obtained by the camera 7 of the mobile device 2. The image can be a two-dimensional image or a three-dimensional image.

In a track step 42, the mobile device 2 performs tracking to find any tracked objects in the image 20 (as illustrated in FIGS. 2A-B and described above). Each tracked object have been identified in a previous image. Any suitable current or future tracker can be used for this purpose, e.g. medianflow, KCF (kernelized correlation filters) and/or CSRT (discriminative correlation filter with channel and spatial reliability tracker).

From the detections for previous images (object type, probability (of correct category detection) and location in the image) of the category object detection, C_detsₜ₋₁, (if the answer from the specific object detection, S_detsₜ₋₁, is already available it can be used too) and the new image frame t, the object tracker identifies the location of the objects in the new image frame. C_detsₜ here denotes category object detection of image frame at time t and S_detsₜ denotes specific object detection of image frame at time t. The output of the object tracker of image frame at time t, T_detsₜ, comprises the set of new locations for the detected (tracked) objects (consider the moved tree in FIG. 2B). In the category object detection and specific object detection, each identified object is given an object label, this label is propagated to the T_detsₜ. In this way, the mobile device 2 knows which detections contain the same objects over different image frames. If S_detsₜ₋₁ were not received before tracking, we can track using only C_ detsₜ₋₁ and update the specific labels of the tracked detections (T_detsₜ) when S_detsₜ₋₁ are received.

Object tracking is a lightweight and fast process as it normally relies on fast optical flow calculations for a limited set of points within each object.

In a category object detection step 45, the mobile device 2 performs category object detecting of the image, resulting in a respective category label for each detected object 25a-c. Examples of approaches that can be used to build the category object detector are MobileNetV2, tiny-YOLO (you only look once) v4, EfficientNet-B7, ResNet-18, CSPNet (cross stage partial network) and DSSD (deconvolutional single shot detector).

Lightweight category object detection is the process of, given an image frame, identifying the category label of the objects contained in the image. Categories refer to a broad and general label that gives sufficient information of the object but allows grouping of similar object types. Categories can be specified for different applications but some examples are: (1) in urban environments categories can be vehicle, infrastructure, vegetation, etc; (2) in animal identification categories can be mammals, reptiles, birds, etc; or (3) in indoor environments categories can be set according to functionality as sitting furniture, illumination, tech devices, etc. The main purpose of the lightweight category object detection is to identify the category of the objects that are new in the processed image frame (new objects compared to previous image frame, consider the lorry in FIG. 2B). To be considered a valid classification result, the category detection should have a probability (of correct object detection) that is higher than a threshold th1.

In one embodiment, both the tracking and the category object detecting is based on the whole image 20. For each image frame, the mobile device 2 can thereby have redundant information, as the objects that were also present in the previous image frame should be recognized both from the tracker and the detector. This embodiment does not require any additional image frame pre-processing but increases the power consumption in the device as every image frame is processed by both the tracker and the detector. The redundancy in the detections can be exploited in at least two ways.

A first way to exploit the redundancy is to identify errors in the tracker by correcting the estimated positions of the bounding boxes or help to track objects that have been partially occluded. If an object has been partially occluded by other, it is probable that the tracker cannot match enough points between the detections. However, using the detection of the remaining visible area of the object we could try to match the points that correspond to that area.

A second way to exploit the redundancy is to identify errors in the category object detection process, as an object that was previously detected with a category label X can be successfully tracked and simultaneously detected again with a category label Y. In this case we can keep both category labels and prioritize them according to their number of appearances until the result is considered non-ambiguous (one label keeps appearing substantially more than the other).

When the category object detection is done, several options exist. In one option, only the label for the best category (category with the highest probability on the detection) is stored. In one option, the top-K labels from the detection are stored. In one option, all labels that surpass a threshold probability value are stored.

In a send request step 47, the mobile device 2 sends a request to a server 3 to perform specific object detecting of at least one object detected in the category object detecting. The request comprises the image, or a reference to the image. As explained above, the specific object detection is a more granular object detecting than the category object detecting. Also, the specific object detection may use more resources (CPU, memory) than the category object detection.

The mobile device 2 can identify the new objects by comparing the outputs from the category object detection and the tracker. If some detection is obtained by the category object detection and not by the tracker, this is identified as a new object. This is then a reason to request specific object detection by the server. The outputs of the category object detection and tracker can be compared according to labels and intersection over union (IoU) of their bounding boxes.

In one embodiment, the sending 47 a request is performed less frequently than the performing 45 category object detecting of the image. This allows images with objects to perform specific object detection for to accrue over a period of time, e.g. to make the communication more efficient.

The specific object detection by the server can be performed in different ways for: (1) every new detection by sending the whole image or (2) every new detection by sending the region that contains the new detection.

The specific object detection is the process of, given an image frame, identifying the specific labels of the objects contained in the image. Specific labels refer to labels that are more granular level than the category labels. The level of specificity of the labels will depend on the applications but some examples are: (1) in urban environments specific labels for category label of vehicle can be car, truck, bus, etc; (2) in another urban environment more specific labels can be required as the brand of the vehicles. The main purpose of the specific object detection is to identify the specific label of the objects that need to be processed further for this image frame.

Similar to the category object detection, the specific object detection can evaluate the whole image or just the region of the image that contains the new object. In addition, it can store only the best classification (label with the highest probability on the detection), store top-K labels from the detection or the number of labels that surpass a threshold probability value. In addition to be considered a valid classification result the specific detection should have a probability (of correct object detection) higher than a threshold th2.

There are several possible embodiments of the structure of the specific object detector. In one embodiment, the specific object detection consists of a single powerful model (e.g. a DNN (deep neural network) for object detection) to infer the specific label of the object. In one embodiment, one model (e.g. DNN) is available for each of the possible categories that can infer the most probable type of object within that category. If the result of the category object detection is only the most probable category, the server would start the specific inference for that category. On the contrary, if the result from the category is a set of most probable categories, the server would launch the specific inference for each category.

The results of the specific object detection (specific label(s) and probability/-ies) can be sent back to the scheduler to select the category-specific label pair that would be assigned to the final detection (bounding box, category label, specific label and category and specific probabilities).

Looking now to FIG. 3B, only new or modified steps in relation to FIG. 3A will be described.

In an optional determine specific object detection set step 46, the mobile device 2 determines a specific object detection set, consisting of at least one object that is to be detected using specific object detecting.

For instance, the specific object detection set can be determined to contain any objects that have been category detected but is not a tracked object. In other words, the specific object detection set then contains any category-detected, new objects in the image. The other objects are already tracked and have been assigned specific labels when they were new. This limits the amount of processing for communication and specific object detection.

Alternatively, the specific object detection set is determined to contain any (i.e. all) objects for which a previous iteration of merging 49 the category label and the specific label was inconclusive. Using the specific object detection, this ambiguity can hopefully be resolved.

When the object detection set is determined, the request in the send request step 47 is for a server to perform specific object detection only for the one or more objects in the specific object detection set.

Alternatively or additionally, category object detection outputs the new objects in the image and objects that were not tracked successfully. So, any detection of the category object detection the mobile device 2 is also forwarded to the server for specific object detection.

In an optional receive response step 48, the mobile device 2 receives a response from the server. The response comprises at least one specific label for each object 25a-c indicated in the request.

In an optional merge step 49, the mobile device 2 merges the category label and the specific label for at least one object 25a-c indicated in the request.

If the application requesting the object detection requires that a label is available fast, the category result would be made available when available, and then, when the specific results is obtained, the information could be extended/modified. This would imply that for such applications, the specific label for the new object would be unknown until its value is inferred. The specific label would be available depending on network conditions (i.e. in poor network conditions, for a newly detected object C_dets would be available for the first image frame but S_dets could take some image frames or ms to appear). In case of offline applications, the delay for the specific object detection is not as important and each image frame will have its C_dets and S_dets.

In order to merge the object detections, a look-up-table or similar with the correspondences between category and specific labels can be used. The merging strategy can differ depending on how many result labels are stored from the category object detection and specific object detection.

According to embodiments presented herein, a requesting application is provided object detection with accurate labels of the objects. The category object detection provides general labels fast and accurately (at its level) so the application can adapt fast or expose that information while the more specific label is being calculated. For a newly detected object, the category label will be available in time t and the specific label in t+epsilon, where epsilon is a small value if network quality is good and larger otherwise.

To be able to assign a category and specific label to an object, an ontology or register of which category labels correspond to which specific labels can be exploited. This initial register can be automatically built using publicly available datasets that provide both labels (COCO data format, COCO supercategory list, CIFAR-100 superclasses) or commonsense datasets (e.g. ConceptNet). In addition, the category and specific object detection can be used to update this register in order to (1) provide a faster response of the specific object detection, or what is the same reduced epsilon, for repetitive situations, and (2) provide a faster category label or specific label for repetitive conflicting situations.

To enhance the performance in (1), each category and specific combination that has been observed in the last L image frames with high confidence for both labels can be given a score. This score will be a linear combination of the average confidence of the category label, the average confidence of the specific label and the number of times that the specific combination was seen in the L image frames. For each new object that gets assigned a category detection (C_i), the mobile device 2 can evaluate whether the confidence for C_i is higher than a threshold th3 and whether that category label has a combination score to any specific label that satisfies that score>threshold th4 and 2^{nd}_score<threshold th5 (this means that the combination for a certain category-specific labels has a high score and the next best combination has a considerably lower score). In this situation, when adding the category label, the mobile device 2 can set a quick guess for the specific label during epsilon that can be confirmed or changed when the actual label is received. This register will be updated for every detection (when the mobile device 2 only runs the category object detection or tracker, and when category and specific object detection are executed) so it represents as best as possible the near past of the current observation.

Regarding (2), conflicting situations provide an insight of the possible biases that the object detectors used might have. For instance, some object detectors such as Yolo-4 or Mask R-CNN have issues to identify bookshelves and they normally detect them as trains. In this case, a category object detection would be saying that the object is a piece of furniture while the specific object detection will sometimes say that it is a bookshelf or a train. Once a conflict is resolved, we can add as attributes to the category and specific combinations in the register the other hypothesis for the combination and a conflict score that indicates how many times this combination was the winning one. Then, for each new object that is involved in a conflict situation (this can imply that epsilon will be longer as the object needs to be reobserved), the mobile device 2 can check the register to look for similar conflicting situations in the past and their conflict score. If the conflict score for one of the similar situations is higher than a threshold th6 and for the rest of similar situations is below a threshold th7, the specific label can be assigned to the winning combination. However, it is good to keep processing this detection for upcoming image frames in order to verify the specific object detection.

Thus, by using a separate category object detection and specific object detection, the mobile device 2 is able to provide even faster responses with decent accuracy based on its past experiences.

In one embodiment, the merging comprises, for each merged object, setting a category label to the most likely detected category label and setting a specific label detection to the most likely detected specific label. If the detectors only expose the best result and there is a correspondence between labels, C_dets and S_dets that are registered for that image. On the contrary, we could register elements with probabilities lower than the threshold as unknown and elements with divergent results also as unknown or with both possible C_dets (the one found by the category object detection and the one corresponding to the specific label) and the obtained S_dets until a corresponding match is found (this detection would be processed again by the category and specific object detection until the result is non-ambiguous).

In one embodiment the category object detection results in a single most likely category label for each object, and the response comprises m most likely specific labels for each object. In this case, the merging comprises, for each merged object, finding within the m most likely specific labels a matching specific label that is a species of the single most likely category object. Furthermore, the merging comprises setting the category label for the merged object to the single most likely category label and setting the specific label to the matching specific label.

In one embodiment, the category object detecting results in n most likely category labels for each object, and the response comprises m most likely specific labels for each object. In this case, the merging comprises, for each merged object, finding a matching category label, within the n most likely category labels, that is a genus of at least one of the m most likely specific labels, denoted a matching specific label. The merging further comprises setting the category label for the merged object to the matching category label and setting the specific label to the matching specific label.

The category object detection and specific object detection are then provided to the requesting application. On the other hand, for detections that there was no need to perform object detection, the results from the tracker are sent to the requesting application. From the tracker results we can get the category label and the specific label thanks to the propagation of information between the detectors and the tracker.

The merging embodiments strategy assumes that both object detections (category and specific) are similarly trustful. If the mobile device 2 had any evidence that one of the detectors is more reliable than the other, the merging can be biased towards the most trustful one when there are ambiguities.

Looking now to FIG. 3C, only new or modified steps in relation to FIGS. 3A-B will be described.

In an optional determine non-tracking region step 44, the mobile device 2 determines (in pre-processing) a non-tracking region 21 within the image 20, wherein the non-tracking region 21 excludes all object(s) that are tracked in the track step 42.

In this case, the performing 45 category object detecting is performed only for the non-tracking region 21.

This embodiment results in more lightweight processing, since category object detection is only performed in the non-tracking regions only. In this embodiment, the pre-processing can even determine if it is worth performing category object detection in any part of the image frame at all, as if the areas not occupied by tracked objects are sufficiently small it can be assumed that they cannot contain any object of significance.

Looking now to FIG. 3D, only new or modified steps in relation to FIGS. 3A-C will be described. This embodiment relies on a two-stage object detector.

In an optional determine suggested regions step 41, the mobile device 2 determines one or more suggested regions in the image 20 for category object detection. In this step, a first stage of the two-stage object detector, called a region proposal network is used. The region proposal network is used to get the suggested regions.

In an optional match step 43, the mobile device 2, after the track step 42, the mobile device 2 matches the one or more suggested regions proposals against respective locations in the image 20 of tracked objects.

In this embodiment, the category object detection step 45 comprises performing category object detection only for any suggested regions where no match is found against tracked objects. This step then forms a second stage of the two-stage object detector, in which the object detection occurs.

Hence, suggested regions are determined for every image frame, but the category object detection is only performed for regions where there is no match against the tracked objects. This reduces power required for the category object detection and can manage overlapping objects, as it will generate a bounding box for each object.

Embodiments presented herein enable a mobile device to perform accurate and low-computational object detection by a lightweight category object detection. By reducing the number of labels from which to choose (category labels are fewer than specific labels), we allow less power-demanding and faster object detection inference in the mobile device. In addition, as elements from the same category may share similar appearance, we can increase accuracy by reducing the number of object detection errors between similar objects.

The proposed method also allows local category object detection to proceed even when the network is not available. In other words, an accurate (category) label can be obtained for objects in the image even when network is not available, and the specific object detection is not reachable.

The server-side specific object detection offers accurate specific results.

Moreover, by running specific object detection only when needed, we avoid unnecessary server processing and communication, while still benefiting from the accurate results when needed. Specific object detection can also help in correcting the category results, when applicable.

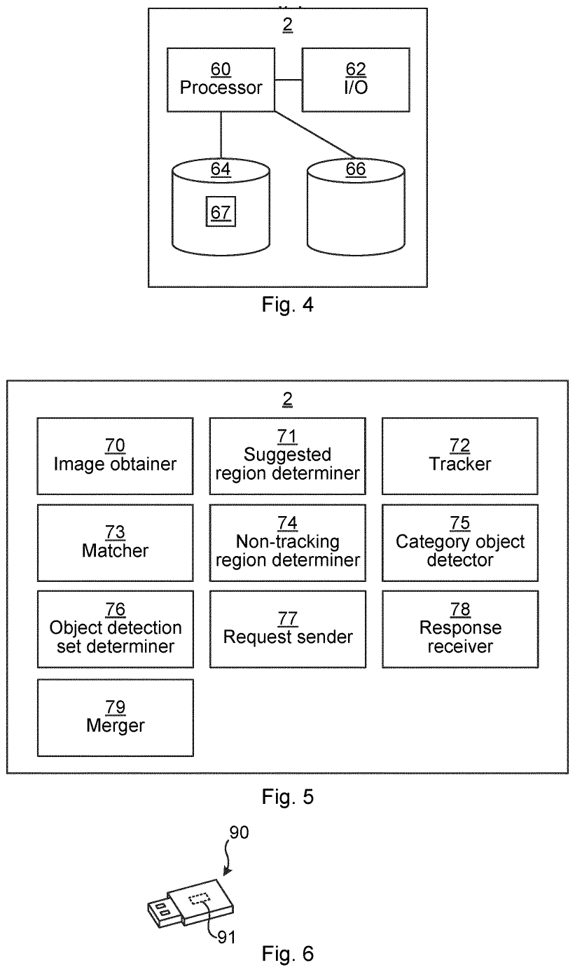

FIG. 4 is a schematic diagram illustrating components of the mobile device 2 of FIG. 1. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 3A-D above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wireless communication, e.g. Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable. Optionally, the I/O interface also supports wired communication, e.g. based on USB (Universal Serial Bus), Ethernet, etc.

Other components of the mobile device 2 are omitted in order not to obscure the concepts presented herein.

FIG. 5 is a schematic diagram showing functional modules of the mobile device 2 of FIG. 1 according to one embodiment. The modules are implemented using software instructions such as a computer program executing in the mobile device 2. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A-D.

An image obtainer 70 corresponds to step 40. A suggested region determiner 71 corresponds to step 41. A tracer 72 corresponds to step 42. A matcher 73 corresponds to step 43. A non-tracking region determiner 74 corresponds to step 44. A category object detector 75 corresponds to step 45. An object detection set determiner 76 corresponds to step 46. A request sender 77 corresponds to step 47. A response receiver 78 corresponds to step 48. A merger 79 corresponds to step 49.

FIG. 6 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 4. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for detecting objects in an image, the method being performed by a mobile device, the method comprising:
obtaining an image to process;
performing tracking to find any tracked objects in the image, wherein any tracked objects have been identified in a previous image;
performing category object detecting of the image, resulting in a respective category label for each detected object; and
sending a request to a server to perform specific object detecting of at least one object detected in the category object detecting, wherein the specific object detecting is a more granular object detecting than the category object detecting.

2. The method of claim 1, further comprising:
receiving a response from the server, the response comprising at least one specific label for each object indicated in the request; and
merging the category label and the specific label for at least one object indicated in the request.

3. The method of claim 2, wherein the merging comprises, for each merged object, setting a category label to the most likely detected category label and setting a specific label detection to the most likely detected specific label.

4. The method of claim 2, wherein the category object detecting results in a single most likely category label for each object, and the response comprises m most likely specific labels for each object, wherein the merging comprises, for each merged object, finding within the m most likely specific labels a matching specific label that is a species of the single most likely category object, setting the category label for the merged object to the single most likely category label and setting the specific label to the matching specific label.

5. The method of claim 2, wherein the category object detecting results in n most likely category labels for each object, and the response comprises m most likely specific labels for each object, wherein the merging comprises, for each merged object, finding a matching category label, within the n most likely category labels, that is a genus of at least one of the m most likely specific labels, denoted a matching specific label, setting the category label for the merged object to the matching category label and setting the specific label to the matching specific label.

6. The method of claim 1, wherein the tracking and the category object detecting is based on the whole image.

7. The method of claim 1, further comprising, prior to the performing category object detecting:
determining a non-tracking region within the image, wherein the non-tracking region excludes all object(s) that are tracked in the performing tracking;
and wherein the performing category object detecting is performed only for the non-tracking region.

8-12. (canceled)

13. A mobile device for detecting objects in an image, the mobile device comprising:
a processor; and
a memory storing instructions that, when executed by the processor, cause the mobile device to:
obtain an image to process;
perform tracking to find any tracked objects in the image, wherein any tracked objects have been identified in a previous image;
perform category object detecting of the image, resulting in a respective category label for each detected object; and
send a request to a server to perform specific object detecting of at least one object detected in the category object detecting, wherein the specific object detecting is a more granular object detecting than the category object detecting.

14. The mobile device of claim 13, further comprising instructions that, when executed by the processor, cause the mobile device to:
receive a response from the server, the response comprising at least one specific label for each object indicated in the request; and
merge the category label and the specific label for at least one object indicated in the request.

15. The mobile device of claim 14, wherein the instructions to merge comprise instructions that, when executed by the processor, cause the mobile device to, for each merged object, set a category label to the most likely detected category label and set a specific label detection to the most likely detected specific label.

16. The mobile device of claim 14, wherein the category object detecting results in a single most likely category label for each object, and the response comprises m most likely specific labels for each object, wherein the instructions to merge comprise instructions that, when executed by the processor, cause the mobile device to, for each merged object, find within the m most likely specific labels a matching specific label that is a species of the single most likely category object, set the category label for the merged object to the single most likely category label and set the specific label to the matching specific label.

17. The mobile device of claim 14, wherein the category object detecting results in n most likely category labels for each object, and the response comprises m most likely specific labels for each object, wherein the instructions to merge comprise instructions that, when executed by the processor, cause the mobile device to, for each merged object, find a matching category label, within the n most likely category labels, that is a genus of at least one of the m most likely specific labels, denoted a matching specific label, set the category label for the merged object to the matching category label and set the specific label to the matching specific label.

18. The mobile device of claim 13, wherein the tracking and the category object detecting is based on the whole image.

19. The mobile device of claim 13, further comprising instructions that, when executed by the processor prior to the performing category object detecting, cause the mobile device to:
determine a non-tracking region within the image, wherein the non-tracking region excludes all object(s) that are tracked in the performing tracking;
and wherein the instructions to perform category object detecting is performed only for the non-tracking region.

20. The mobile device of claim 13, further comprising instructions that, when executed by the processor prior to the performing tracking, cause the mobile device:
determine one or more suggested regions in the image for category object detecting;
and, instructions that, when executed by the processor after the performing tracking, cause the mobile device to match the one or more suggested regions proposals against respective locations in the image of tracked objects;
wherein the performing category object detecting is performed only for any suggested regions where no match is found against tracked objects.

21. The mobile device of claim 13, further comprising instructions that, when executed by the processor, cause the mobile device to:
determine a specific object detection set, consisting of at least one object that is to be detected using specific object detecting; and
wherein, in the instructions to send a request, the request is for a server to perform specific object detecting only for any objects in the specific object detection set.

22. The mobile device of claim 21, wherein the specific object detection set contains any objects that have been category detected but is not a tracked object.

23. The mobile device of claim 14, wherein
the mobile device is further configured to:
receive a response from the server, the response comprising at least one specific label for each object indicated in the request;
merge the category label and the specific label for at least one object indicated in the request;
determine a specific object detection set, consisting of at least one object that is to be detected using specific object detecting, wherein, in the instructions to send a request, the request is for a server to perform specific object detecting only for any objects in the specific object detection set, and
the specific object detection set contains any objects for which a previous iteration of instructions to merge the category label and the specific label was inconclusive.

24. The mobile device of claim 13, wherein the instructions to send a request are performed less frequently than the instructions to perform category object detecting of the image.

25. A non-transitory computer readable storage medium storing a computer program for detecting objects in an image, the computer program comprising computer program code which, when executed on a mobile device causes the mobile device to:
obtain an image to process;
perform tracking to find any tracked objects in the image, wherein any tracked objects have been identified in a previous image;
perform category object detecting of the image, resulting in a respective category label for each detected object; and
send a request to a server to perform specific object detecting of at least one object detected in the category object detecting, wherein the specific object detecting is a more granular object detecting than the category object detecting.

26. (canceled)
